(19) United States
(12) Patent Application Publication
(10) Pub. No.: US 2025/0381839 A1
(43) Pub. Date: Dec. 18, 2025

(54) VALVE ASSEMBLY FOR FUEL TANKS

(71) Applicant: Eaton Intelligent Power Limited, Dublin 4 (IE)

(72) Inventors: Chandan Mohapatra, Pune (IN); Daniel Lee Pifer, Chelsea, MI (US); Abhinav Sharma, Hadapsar (IN); Russell S. Trapp, Dexter, MI (US); Vaughn Mills, Chelsea, MI (US)

(21) Appl. No.: 19/316,749

(22) Filed: Sep. 2, 2025

Related U.S. Application Data
(63) Continuation of application No. PCT/IB2024/052735, filed on Mar. 21, 2024.

(30) Foreign Application Priority Data
Mar. 22, 2023 (IN) 202311019814

(51) Int. Cl. B60K 15/035; B60K 15/03; F16K 27/02

(52) U.S. Cl. CPC B60K 15/035; F16K 27/0245; B60K 2015/03263; B60K 2015/03289; B60K 2015/03296

(57) ABSTRACT

A valve assembly may include a Fill Limit Vent Valve (FLVV) for preventing overfilling of the fuel tank during a refueling event, the FLVV comprising a first vapor path and a first float for selectively opening and closing the first vapor path based on fuel level in the fuel tank. The valve assembly may include a Grade Vent Valve (GVV) for releasing pressure in the fuel tank, wherein the GVV has a housing with an interface end connected to the FLVV and a ventilation end that comprises a ball-type valve for opening and closing a second vapor path of the GVV. The valve assembly may include a canister enveloping at least the ventilation end of the housing of the GVV, wherein the ventilation end of the housing of the GVV comprises (a) an orifice coupled to the first vapor path of the FLVV, and (b) a head cage for confining movements of a ball of the ball-type valve. The head cage is defined by at least a plurality of walls comprising: a first curved wall with a first end terminating at the orifice for the first vapor path of the FLVV and a second end terminating at a first terminating location proximate to a side boundary of the ventilation end of the housing; and a second curved wall with a third end terminating at the orifice for the first vapor path of the FLVV and a fourth end terminating at a second terminating location proximate to the side boundary of the ventilation end of the housing.

### PRIORITY

This application claims the benefit under 35 U.S.C. § 365 (c) of International Patent Application No. PCT/IB2024/052735, filed 21 Mar. 2024, which claims the benefit under 35 U.S.C. § 119 (a) of India patent application No. 202311019814, filed on 22 Mar. 2023, the entire contents of which are hereby incorporated by reference for all purposes as if fully set forth herein.

### TECHNICAL FIELD

This disclosure generally relates to a fuel tank system and, more particularly, to a valve assembly to control pressure in the tank.

### BACKGROUND

Fuel tank valves function to control emissions from a fuel tank and release pressure therein. Fuel vapors are vented through the valves and into a canister where vapors are stored. Fill Limit Vent Valves (FLVV) prevents overfilling of the fuel tank during a refueling event. Once the fuel tank has reached its maximum fill level, the FLVV will close to prevent overfilling. Throughout the refueling event, fuel vapor can escape through the FLVV and into the canister. Grade vent valves (GVV) allow fuel tanks to vent when parked on a grade. When the pressure in the fuel tank rises above a threshold level, the GVV will open to allow fuel vapor to escape into the canister. A Compact Combo Valve (CCV), as used herein, refers to a vent valve that stacks a FLVV and a GVV to provide the functionalities of both, thereby providing a compact solution for emission control in different vehicle conditions.

Traditional CCV systems utilize a disk valve for GVV venting. The disk valve includes a stainless-steel disk (SSD) that can move up and down to respectively open and close the GVV's orifice. The GVV's housing includes a circular head cage to limit the lateral movement of the SSD. The SSD, which may be cylindrical, is designed to selectively open and close an orifice of the GVV based on the pressure within the fuel tank. When pressure is low, the base portion of the SSD is seated against a surface within the head cage to cover the orifice. Since the head cage limits the lateral movement of the SSD, the SSD will not move and open the orifice of the GVV in response to vehicle movement. When the disk is eventually lifted due to pressure build-up, pressurized vapor could escape through the now-opened orifice and drag liquid fuel particles out of the fuel tank, which is undesirable.

### SUMMARY

The present disclosure provides an improved valve assembly that can release pressure in a fuel tank when the vehicle is in dynamic motion. In particular, the present disclosure relates to a valve assembly that includes a Fill Limit Vent Valve (FLVV) and a Grade Vent Valve (GVV) (the valve assembly may be referred to as a compact combo valve (CCV)). The FLVV may prevent fuel tank overfilling during a refueling event. The FLVV has a first vapor path through which vapor and pressure from the fuel tank may escape into a storage unit. The FLVV includes a first float configured to selectively open and close the first vapor path based on the fuel level in the fuel tank. The GVV, on the other hand, is designed to release the pressure in the fuel tank when the vehicle is parked on a grade or moving. The bottom end of the GVV's housing is referred to as an interface end because it is designed to interface or connect with the FLVV. In this manner, the GVV may be stacked on top of the FLVV. The top end of the GVV's housing is referred to as a ventilation end (an outlet port) because it is the end of the housing through which vapor emissions may escape and be captured by a canister (for example, a carbon canister). The ventilation end of the housing of the GVV includes a first orifice, also known as a central orifice, coupled to the first vapor path of the FLVV. The ventilation end of the GVV housing also includes a second orifice through which vapor pressure may escape via a second vapor path of the GVV. The GVV housing may use a ball-type valve to open and close the second vapor path of the GVV. The ventilation end of the housing further includes a head cage for confining movements of a ball of the ball-type valve.

The ball-type valve for the GVV has the benefit of being able to open when the vehicle is moving. This is in contrast to conventional valve assemblies with stainless-steel disk valves, which can only open in response to built-up pressure in the fuel tank. The ball-type valve used in the present embodiments could advantageously open and release pressure in response to vehicle movement, thereby avoiding excessive pressure to build up in the fuel tank.

The GVV's housing may include a head cage to limit the range of lateral movement of the ball of the ball-type valve. The size of the head cage is preferably large relative to the size of the ball to provide sufficient space for the ball to roll away from the GVV orifice. However, since the ventilation end of the GVV housing needs to accommodate both the FLVV orifice and the head cage for the GVV orifice, there is limited space to expand the size of the head cage for the ball-type valve.

In an embodiment, the head cage may have a plurality of walls instead of a single continuous wall. The walls may be curved to provide concave surfaces for the ball to roll against. A first curved wall of the plurality of walls may have (1) a first end that terminates at the (central orifice) orifice for the first vapor path of the FLVV and (2) a second end that terminates at a first termination location proximate to a side boundary of the ventilation end of the housing. A second curved wall of the plurality of walls may have a third end terminating at the orifice (central orifice) for the first vapor path of the FLVV and a fourth end terminating at a second termination location proximate to the side boundary of the ventilation end of the housing. The plurality of walls may have gaps between each other and/or other structural elements of the valve assembly, so long as the gaps are smaller than the diameter of the ball to prevent the ball from escaping the head cage.

In particular embodiments, the utilization of a ball for the ball-type valve results in a lower level of liquid carry-over (LCO) during a dynamic condition of the vehicle. In particular embodiments, a stainless steel ball (referred to as a head valve ball or SS ball) is placed in a head cage that surrounds an orifice of the GVV. A slanting surface within the head cage forms a downward slant to bias the stainless steel ball towards the orifice of the GVV under the pull of gravity. Thus, in operation, the ball would roll around within the head cage due to the motion of the vehicle, thereby opening the orifice of the GVV to release pressure in the fuel tank. When the vehicle is stationary, the ball will eventually be biased by the slanting surface within the head cage to rest on top of the orifice of the GVV, thereby closing it.

The embodiments disclosed herein are only examples, and the scope of this disclosure is not limited to them. Particular embodiments may include all, some, or none of the components, elements, features, functions, operations, or steps of the embodiments disclosed herein. The dependencies or references back in the attached claims are chosen for formal reasons only. However, any subject matter resulting from a deliberate reference to any previous claims (in particular multiple dependencies) can be claimed as well so that any combination of claims and the features thereof are disclosed and can be claimed regardless of the dependencies chosen in the attached claims. The subject matter that can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims. Additional objects and advantages will be set forth in part in the description that follows and, in part, will be obvious from the description or may be learned by practice of the disclosure. The objects and advantages will also be realized and attained by means of the elements and combinations particularly pointed out in the appended claims. It is to be understood that both the foregoing general description and the following detailed description are exemplary and explanatory only and are not restrictive of the claimed invention.

In some aspects, the techniques described herein relate to a valve assembly for a fuel tank of a vehicle, the valve assembly including: a Fill Limit Vent Valve (FLVV) for preventing overfilling of the fuel tank during a refueling event, the FLVV including a first vapor path and a first float for selectively opening and closing the first vapor path based on fuel level in the fuel tank; a Grade Vent Valve (GVV) for releasing pressure in the fuel tank, wherein the GVV has a housing with an interface end connected to the FLVV and a ventilation end that includes a ball-type valve for opening and closing a second vapor path of the GVV; and a canister enveloping at least the ventilation end of the housing of the GVV; wherein the ventilation end of the housing of the GVV includes (a) an orifice coupled to the first vapor path of the FLVV, and (b) a head cage for confining movements of a ball of the ball-type valve, the head cage being defined by at least a plurality of walls including: a first curved wall with a first end terminating at the orifice for the first vapor path of the FLVV and a second end terminating at a first terminating location proximate to a side boundary of the ventilation end of the housing; and a second curved wall with a third end terminating at the orifice for the first vapor path of the FLVV and a fourth end terminating at a second terminating location proximate to the side boundary of the ventilation end of the housing.

In some aspects, the techniques described herein relate to a valve assembly, wherein the plurality of walls forms at least a portion of a circumferential enclosure around the ball-type valve.

In some aspects, the techniques described herein relate to a valve assembly, wherein at least the first terminating location of the first curved wall or the second terminating location of the second curved wall is at the side boundary of the ventilation end of the housing.

In some aspects, the techniques described herein relate to a valve assembly, wherein a gap between the first end of the first curved wall and the third end of the second curved wall includes a portion of the orifice for the first vapor path of the FLVV.

In some aspects, the techniques described herein relate to a valve assembly, wherein a diameter of the ball of the ball-type valve is larger than the gap.

In some aspects, the techniques described herein relate to a valve assembly, wherein the ball-type valve includes a second orifice surrounded by a slanting surface that slants down towards the second orifice.

In some aspects, the techniques described herein relate to a valve assembly, wherein the slanting surface extends from the second orifice to the first curved wall and the second curved wall.

In some aspects, the techniques described herein relate to a valve assembly, wherein the slanting surface further extends to the side boundary of the ventilation end of the housing.

In some aspects, the techniques described herein relate to a valve assembly, wherein the first curved wall, the second curved wall, and an interior surface of the canister confines movements of the ball of the ball-type valve.

In some aspects, the techniques described herein relate to a valve assembly, wherein the housing of the GVV, including the first curved wall and the second curved wall, is molded from a single piece of material.

In some aspects, the techniques described herein relate to a valve assembly, wherein the ball of the ball-type valve has a diameter that is larger than a gap between the second end of the first curved wall and the side boundary of the ventilation end of the housing.

In some aspects, the techniques described herein relate to a valve assembly, wherein the first curved wall and the second curved wall are disjoint.

In some aspects, the techniques described herein relate to a housing in a valve assembly for a fuel tank of a vehicle, the housing including: an orifice coupled to a first vapor path, and a head cage for confining movements of a ball of a ball-type valve that opens and closes a second vapor path, the head cage being defined by at least a plurality of walls including: a first curved wall with a first end terminating at the orifice for the first vapor path and a second end terminating at a first terminating location proximate to a side boundary of the housing; and a second curved wall with a third end terminating at the orifice for the first vapor path and a fourth end terminating at a second terminating location proximate to the side boundary of the housing.

In some aspects, the techniques described herein relate to a housing, wherein a gap between the first end of the first curved wall and the third end of the second curved wall includes a portion of the orifice for the first vapor path of a Fill Limit Vent Valve (FLVV).

In some aspects, the techniques described herein relate to a housing, wherein a diameter of the ball of the ball-type valve is larger than the gap.

In some aspects, the techniques described herein relate to a housing, wherein the ball-type valve includes a second orifice surrounded by a slanting surface that slants down towards the second orifice.

In some aspects, the techniques described herein relate to a housing, wherein the slanting surface extends from the second orifice to the first curved wall and the second curved wall.

In some aspects, the techniques described herein relate to a housing, wherein the slanting surface further extends to the side boundary of the housing.

In some aspects, the techniques described herein relate to a housing, wherein movements of the ball of the ball-type valve is confined by the first curved wall, the second curved wall, and an interior surface of a canister when the canister is attached to the housing.

In some aspects, the techniques described herein relate to a housing, wherein the first vapor path is associated with a FLVV for preventing overfilling of the fuel tank during a refueling event, and the second vapor path is associated with a Grade Vent Valve (GVV) for venting the fuel tank when the vehicle is parked on a grade.

### BRIEF DESCRIPTION OF THE DRAWINGS

Non-limiting and non-exhaustive embodiments are described with reference to the following Figures, wherein reference numerals refer to like parts throughout the various drawings unless otherwise specified.

FIGS. 1A-1C illustrate an example of a valve assembly that uses a stainless-steel disk to control ventilation operations.

FIG. 2 illustrates an example of valve assembly that includes a GVV and an FLVV, according to particular embodiments.

FIG. 3 illustrates a cross-sectional view of a valve assembly's GVV with a ball-type valve, according to particular embodiments.

FIG. 4 illustrates a perspective view of a valve assembly's GVV housing, according to particular embodiments.

FIG. 5A illustrates a top view of a valve assembly's GVV housing, according to particular embodiments.

FIG. 5B illustrates a cross-sectional view of the slanting surfaces within a head cage of a GVV housing, according to particular embodiments.

FIG. 6 illustrates an example of a perspective view of a valve assembly design with a ball-type valve, according to particular embodiments.

### DETAILED DESCRIPTION

A Compact Combo Valve (CCV) includes the functionalities of both a GVV and an FLVV. In certain CCV designs, the functional components of a GVV are stacked on top of those of an FLVV. As such, the GVV housing needs to be designed to accommodate both the FLVV and GVV. For example, the housing of the GVV may have a central orifice coupled to a first vapor path of the FLVV disposed underneath the GVV. The housing of the GVV may also have a second orifice coupled to a separate vapor path of the GVV.

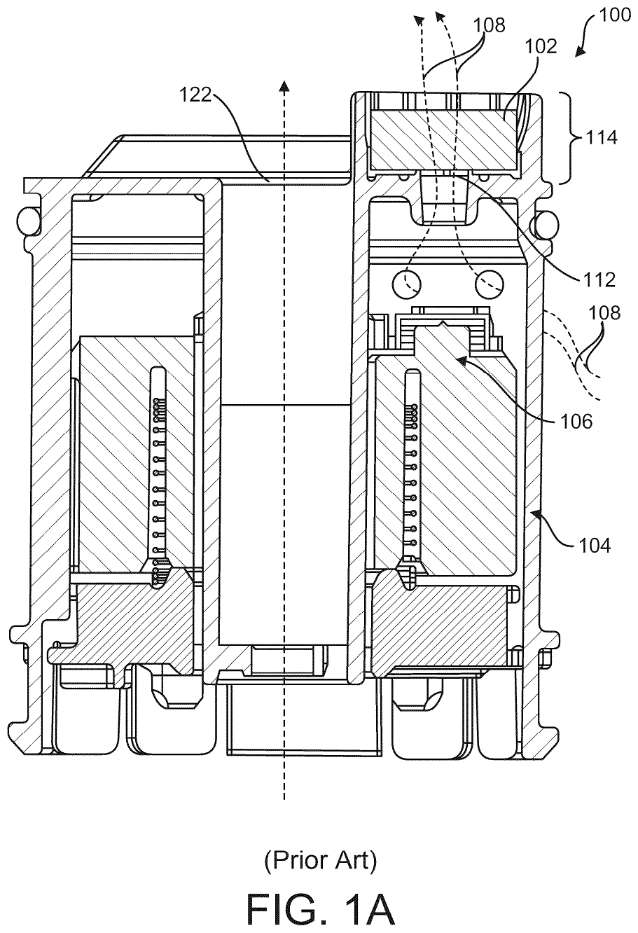

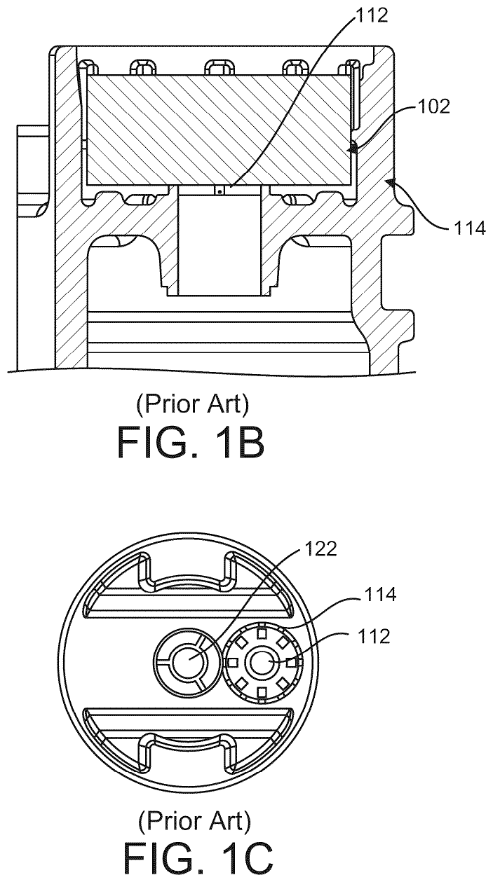

Existing designs may use a stainless-steel disk (SSD) to selectively open and close the second orifice of the GVV to release pressure. FIG. 1A illustrates a cross-sectional view of such an example of the GVV portion of a valve assembly 100 (the valve assembly 100 may be referred to as a CCV). The GVV portion of the valve assembly 100 may include a housing 104, a float 106, a first orifice 122 for the FLVV (also referred to as the central orifice), a second orifice 112 for the GVV (more clearly shown in FIG. 1B), and a circular head cage 114 surrounding the second orifice 112.

The housing 104 of the GVV may include a circular head cage 114 configured to contain a stainless-steel disk (SSD) 102, which is used as a disk valve to open and close the second orifice 112 of the GVV. FIG. 1B shows a cross-section of the circular head cage 114 and SSD 102 and FIG. 1C shows a top view of the housing without the SSD 102. The cross-sectional view shows the SSD 102 placed within the circular head cage 114, covering the aforementioned second orifice 112. The SSD 102 may have a cylindrical shape, and its lateral movement is confined by the circular head cage 114. The base of the SSD 102 is seated against a surface within the circular head cage 114 to cover the second orifice 112. This SSD 102 may have a dimension and/or weight designed and calibrated to move upward by a predetermined pressure (e.g., 5 kPa) in the fuel tank. When pressure within the fuel tank is below the threshold amount, the SSD 102 will remain seated, thereby closing the second orifice 112. When the pressure in the fuel tank rises beyond the threshold amount, the pressure will lift the SSD 102 to open the second orifice 112, thereby allowing vapor pressure to escape.

FIG. 1A shows the manner in which vapor pressure may be released. The GVV has a vapor path 108 through which fuel vapor may escape through the second orifice 112. The approximate vapor path 108 may pass through gaps in the internal structure of the valve assembly. Sufficiently high pressure will lift up the SSD 102, thereby opening the second orifice 112 to allow pressure to be released. However, the SSD 102 can only move vertically within the circular head cage 114 in response to tank pressure. Vehicle movement in dynamic conditions will not cause the second orifice 112 to open due to the circular head cage 114 preventing significant lateral displacement of the SSD 102. Thus, pressure will build up in the fuel tank until the moment when the second orifice 112 opens. Due to the high pressure in the fuel tank at the time when the SSD 102 lifts up, liquid fuel particles may be dragged with the escaping vapor pressure when the second orifice 112 opens. Thus, there is a need for an improved mechanism to avoid pressure build-up in the fuel tank.

Particular embodiments described herein allow the pressure in the fuel tank to be released in dynamic conditions. Instead of using an SSD 102 that can only be lifted by pressure in the fuel tank, embodiments described herein use a ball-type valve that can open and close the GVV's orifice in response to vehicle movements in addition to the fuel tank pressure. The ball of the ball-type valve can roll laterally in response to vehicle movements alone, thereby allowing pressure to be released from the fuel tank in dynamic conditions and avoiding pressure build-up.

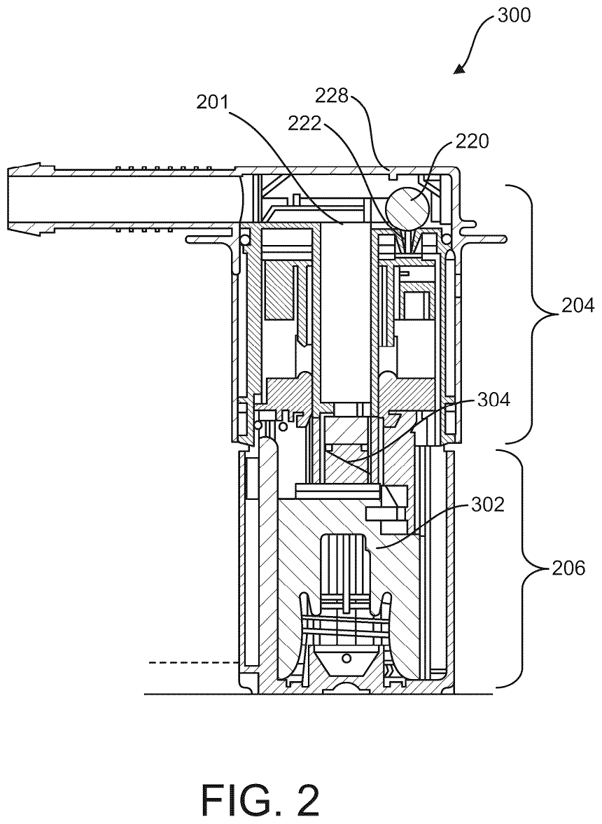

FIG. 2 shows a valve assembly 300 (e.g., a CCV) of a fuel tank of a vehicle, according to particular embodiments. The valve assembly 300 includes a canister (e.g., a carbon canister) 228 covering a GVV 204, which is stacked on top of an FLVV 206. The canister 228 may envelop at least the top portion of the GVV 204 to capture and direct vapor or liquid that has escaped from the GVV 204 and FLVV 206. For example, one end of a tube may be connected to the protruding outlet portion of the canister 228, and the other end of the tube may be connected to the inlet of a container for capturing fuel vapor or liquid.

In an embodiment, the FLVV 206 may be configured to prevent overfilling of the fuel tank during a refueling event. The FLVV 206 may be placed in a fuel tank so that it can sense or detect the fuel level in the fuel tank. In particular embodiments, the FLVV 206 includes a first float 302 that selectively opens and closes a first vapor path based on the fuel level in the fuel tank. The first float 302 moves up and down in the FLVV 206 depending upon the fuel level in the fuel tank. In some embodiments, the FLVV 206 may be attached to a ribbon 304 that may be configured to seal and unseal an inlet of the first orifice 201 based on the movement of the first float 302. When fuel level is low, the first float 302 would move downward, thereby bringing the ribbon 304 downward and away from the inlet of the first orifice 201 (i.e., the vapor path via the first orifice 201 is open). In this state, pressure in the fuel tank will not build up. When the fuel level rises, the first float 302 moves upward. When the first float 302 is at a predetermined height level, the ribbon 304 would close the inlet of the first orifice 201, thereby closing the vapor path. As additional fuel is added, pressure within the fuel tank will increase and ultimately trigger the shutoff mechanism of the fuel pump.

In the embodiment shown in FIG. 2, GVV 204 is stacked on top of the FLVV 206. The GVV 204 has a housing that includes the first orifice 201 for connecting to the first vapor path from the FLVV. GVV 204 further has a second orifice 222 coupled to a second vapor path of the GVV 204. The second orifice 222 is opened and closed using a ball 220, which can roll away and open the second orifice 222 in response to vehicle movement and/or pressure within the fuel tank.

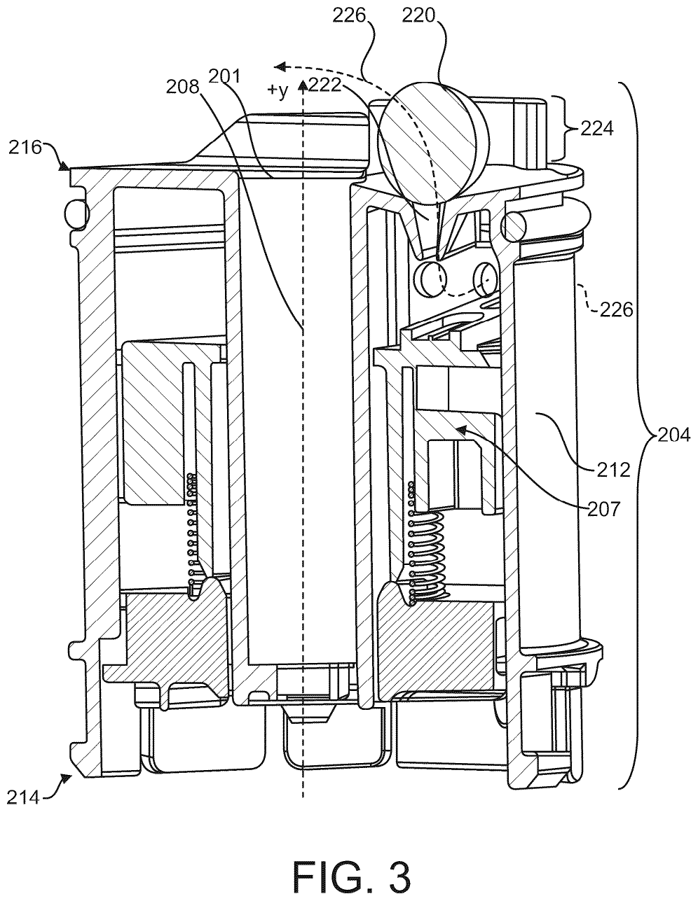

FIG. 3 illustrates an example of a cross-section of the GVV 204 portion of the valve assembly 300 of FIG. 2. The housing 212 of the GVV 204 includes a ventilation end 216 and an interface end 214 for connecting to the FLVV assembly (not shown in FIG. 2). The ventilation end 216 includes a first orifice 201 serving as an outlet for a first vapor path 208 from the FLVV 206, as well as a second orifice 222 serving as an outlet for a second vapor path 226 of the GVV 204. Both the first orifice 201 and the second orifice 222 form outlet conduits for fuel vapors released by the fuel tank. The ventilation end 216 of the GVV 204 has a ball-type valve with a stainless-steel ball (SS ball) 220 configured to open and close the second orifice 222 selectively. Unlike the SSD 102 shown in FIGS. 1A-1B, the ball 220 of the ball-type valve can open the second orifice 222 in response to either pressure in the fuel tank or vehicle movements. In order to define a boundary within which the ball 220 can roll, the GVV 204 housing includes a head cage 224 that surrounds the ball 220 and the second orifice 222. In operation, the ball 220 of the ball-type valve is placed within the head cage 224, which confines the movement of ball 220 in dynamic conditions of the vehicle. For example, the ball 220 may move around and away from and at the second orifice 222 when the vehicle is moving or parked on a grade. In this configuration, the second orifice 222 would be open, thereby allowing low pressure to be maintained in the fuel tank during the vehicle movement, which reduces the LCO of the valve assembly.

In an embodiment, the GVV 204 may include a mechanism to prevent fuel leakage through the second orifice 222. The housing 212 of the GVV 204 includes a second float 207. The upper surface of the float may have a shape or sealing member (e.g., a ribbon) designed to seal the second orifice 222. When a liquid fuel level has caused the second float 207 to move to an uppermost limit within the housing 212, the upper surface of the float, along with any sealing member attached thereto, will cover the inner surface of the second orifice 222, thereby sealing it to prevent unintended leakage of liquid fuel through the second orifice 222.

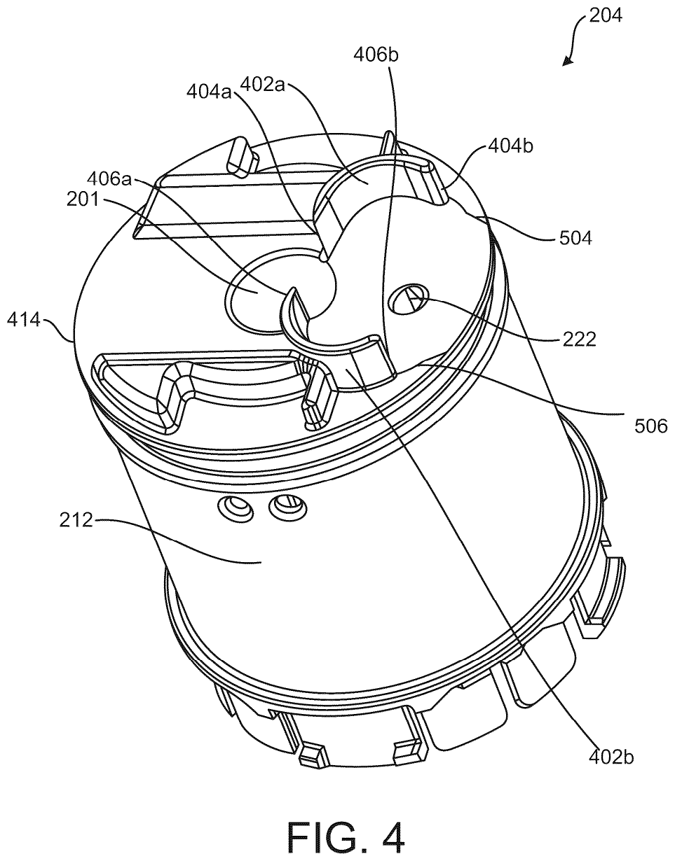

FIG. 4 illustrates a perspective view of the GVV 204 portion of the valve assembly. As previously discussed, the housing 212 of the GVV 204 needs to include both a first orifice 201 for the vapor path of the FLVV 206 and a second orifice 222 for the vapor path of the GVV 204. In the embodiment shown, the first orifice 201 is a circular orifice in the center of the ventilation end 216 of housing 212. The second orifice 222 is disposed between the first orifice 201 and the boundary or edge of housing 212. Since the mechanism used to open and close the second orifice 222 relies on the lateral movements of a ball 220 (not shown in FIG. 4) placed within a head cage, it is desirable for the head cage to be sufficiently large so that the ball has enough space to roll away from the second orifice 222. However, one challenge in doing so is that there is limited space around the second orifice 222 due to the size of the housing 212 and the placements of the first orifice 201 and the second orifice 222. For example, if the head cage around the second orifice 222 forms a circular boundary centered around the second orifice 222, the largest possible circular boundary would have a diameter that extends from the edge of housing 212 to the closest edge of the first orifice 201. The space provided for ball movement within such a circular boundary would be overly restrictive.

The embodiment shown in FIG. 4 provides an improved head cage design that optimizes the allowable space for ball movement. The head cage may be defined by at least a plurality of walls 402, which may be disjoint from one another. In the embodiment shown, the head cage has two walls (402a and 402b), but this disclosure further contemplates using more than two walls (e.g., three or more walls). In an embodiment, the plurality of walls 402 forms circumferential enclosures around the second orifice 222. For example, the plurality of walls 402 creates a bean-shaped circumferential boundary/enclosure for controlling the motions of the ball 220 around the second orifice 222. A first curved wall 402a has a first end 404a terminating at the first orifice 201 for the first vapor path 208 of the FLVV 206 and a second end 404b terminating at a first terminating location proximate to a side boundary 414 of the ventilation end 216 of housing 212. A second curved wall 402b has a third end 406a terminating at the first orifice 201 for the first vapor path 208 of the FLVV 206 and a fourth end 406b terminating at a second terminating location proximate to the side boundary 414 of the ventilation end 216 of the housing 212. In the embodiment shown in FIG. 4, the first curved wall 402a and the second curved wall 402b do not terminate at the side boundary 414 of the housing 212 (in other words, there are gaps between the side boundary 414 and each of the first and second curved walls 402a-b). However, it should be appreciated that in other embodiments, the first and second curved walls 402a-b could extend to the side boundary 414. In particular embodiments, the housing 212 of the GVV 204, including the first curved wall 402a and the second curved wall 402b, may be molded from a single piece of material.

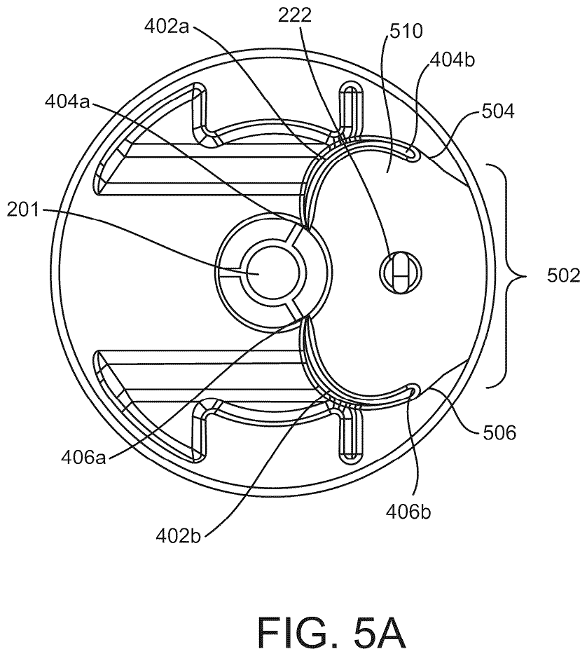

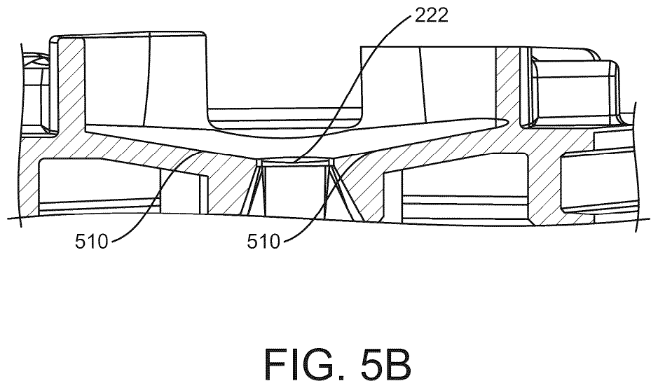

FIG. 5A illustrates a top view of the housing 212 of the valve assembly, according to particular embodiments. The second orifice 222 may be surrounded by a slanting surface 510 that slants down towards the second orifice 222. The slanting surface 510 is shaped like a funnel and helps guide the ball 220 toward the second orifice 222. Thus, when gravity is the only force acting on the ball 220, the ball 220 would roll toward the second orifice 222 and cover it when at rest. In an embodiment, the slanting surface 510 may extend from the second orifice 222 to the first curved wall 402a and the second curved wall 402b. The slanting surface 510 may also extend to a segment of the edge of the first orifice 201 between the first curved wall 402a and the third end 406a of the second curved wall 402b (i.e., the segment of the edge of the first orifice 201 between the first end 404a and the third end 406a). The slanting surface may further extend to a region between the first curved wall 402a and the side boundary 414 of the housing 212. The transition between the slanting surface 510 and the non-slanted top surface of the housing 212 is indicated by line 504. Similarly, the slanting surface 510 may extend to a region between the second curved wall 402b and the side boundary 414 of housing 212. The transition line 506 indicates the transition between the slanting surface 510 and the non-slated top surface of the housing. With the slanting surface 510, the ball 220 may be biased to roll towards and rest over the second orifice 222, thereby closing the second orifice 222 during translation between a dynamic condition and a static condition of the vehicle. FIG. 5B provides a cross-sectional side view of the slanting surface around the second orifice 222 of the ball-type valve of the head cage 224. When the vehicle is in motion, the ball 220 will roll around the second orifice 222 along the slanting surface 510. Under static scenarios, gravity would drag the ball 220 down along the slanting surface 510 towards the second orifice 222 until the ball rests on top of the second orifice 222 and closes it.

In an embodiment, movements of the ball 220 are confined by the first curved wall 402a, the second curved wall 402b, and an interior surface of the canister 228 (see FIG. 2) when it is secured over the valve assembly. Since the plurality of walls 402a-b may be disjoint, the gaps between the walls 402a-b and/or other structural elements of the housing 212 need to be smaller than the diameter of the ball 220 to prevent ball 220 from escaping the head cage. For example, a gap may be present between the first end 404a of the first curved wall 402a and the third end 406a of the second curved wall 402b, as shown in FIG. 5A. A portion of the first orifice 201 may be located between this gap, so long as the ball 220 cannot roll and rest on top of the first orifice 201. The gap is designed to be smaller than the diameter of the ball 220 used by the ball-type valve. For example, the diameter of the ball 220 may be 10.5 mm, and the gap may be less than 10 mm. In a similar manner, gaps between the side boundary 414 of housing 212 and each of the first and second curved walls 402a-b may be smaller than the diameter of the ball 220. Specifically, the ball 220 of the ball-type valve has a diameter that is larger than any gap between the second end 404b of the first curved wall 402a and the side boundary 414 of the ventilation end 216 of housing 212. Similarly, the diameter of the ball 220 is also larger than any gap between the fourth end 406b of the second curved wall 402b and the side boundary 414. In this manner, the ball 220 would not be able to escape the head cage via any of the gaps between the walls 402a-b.

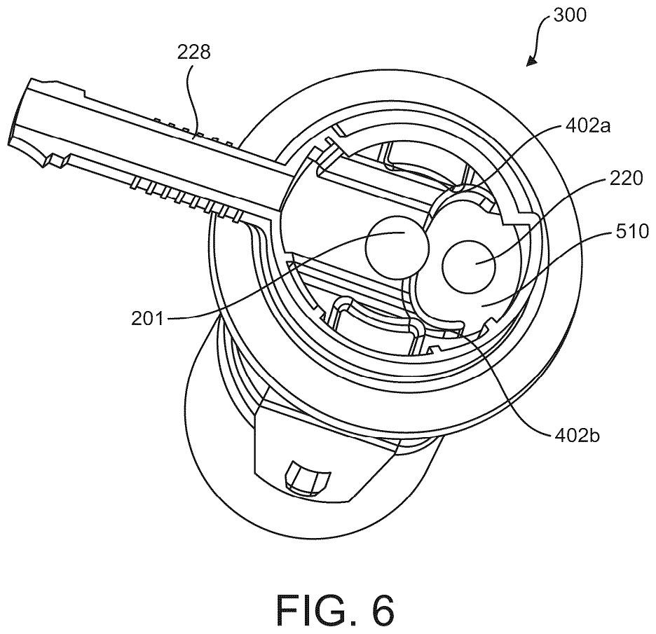

FIG. 6 illustrates a perspective view of the compact combo valve or valve assembly, according to particular embodiments. The canister 228 is secured over the GVV 204 of the valve assembly. The top portion of the canister 228 is removed in FIG. 6 to better illustrate the ball 220 and the head cage formed around it. In FIG. 6, the ball 220 is resting above the second orifice 222, thus blocking it from view. In dynamic conditions, the ball 220 would move away from the second orifice 222 and roll around the slanting surface 510. Lateral movement of the ball 220 is restricted by the curved walls 402a-b and an interior surface of the canister 228 that fits around a portion 502 of the side boundary 414 of the housing 212 that is proximate to the second end 404b of the first curved wall 402a and the fourth end 406b of the second curved wall 402b (see FIG. 5A). Since the boundary defining the allowable movement space of the ball 220 is formed by a plurality of disjoint walls, their relative spacing, and other structural elements of the valve assembly (e.g., the interior surface of the canister 228), the movement space for the ball 220 can be maximized, thereby improving the performance of the ball-type valve used by the valve assembly.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A valve assembly for a fuel tank of a vehicle, the valve assembly comprising:
a Fill Limit Vent Valve (FLVV) for preventing overfilling of the fuel tank during a refueling event, the FLVV comprising a first vapor path and a first float for selectively opening and closing the first vapor path based on fuel level in the fuel tank;
a Grade Vent Valve (GVV) for releasing pressure in the fuel tank, wherein the GVV has a housing with an interface end connected to the FLVV and a ventilation end that comprises a ball-type valve for opening and closing a second vapor path of the GVV; and
a canister enveloping at least the ventilation end of the housing of the GVV;
wherein the ventilation end of the housing of the GVV comprises (a) an orifice coupled to the first vapor path of the FLVV, and (b) a head cage for confining movements of a ball of the ball-type valve, the head cage being defined by at least a plurality of walls comprising:
a first curved wall with a first end terminating at the orifice for the first vapor path of the FLVV and a second end terminating at a first terminating location proximate to a side boundary of the ventilation end of the housing; and
a second curved wall with a third end terminating at the orifice for the first vapor path of the FLVV and a fourth end terminating at a second terminating location proximate to the side boundary of the ventilation end of the housing.

2. The valve assembly of claim 1, wherein the plurality of walls forms at least a portion of a circumferential enclosure around the ball-type valve.

3. The valve assembly of claim 1, wherein at least the first terminating location of the first curved wall or the second terminating location of the second curved wall is at the side boundary of the ventilation end of the housing.

4. The valve assembly of claim 1, wherein a gap between the first end of the first curved wall and the third end of the second curved wall includes a portion of the orifice for the first vapor path of the FLVV.

5. The valve assembly of claim 4, wherein a diameter of the ball of the ball-type valve is larger than the gap.

6. The valve assembly of claim 1, wherein the ball-type valve comprises a second orifice surrounded by a slanting surface that slants down towards the second orifice.

7. The valve assembly of claim 6, wherein the slanting surface extends from the second orifice to the first curved wall and the second curved wall.

8. The valve assembly of claim 7, wherein the slanting surface further extends to the side boundary of the ventilation end of the housing.

9. The valve assembly of claim 1, wherein the first curved wall, the second curved wall, and an interior surface of the canister confines movements of the ball of the ball-type valve.

10. The valve assembly of claim 1, wherein the housing of the GVV, including the first curved wall and the second curved wall, is molded from a single piece of material.

11. The valve assembly of claim 1, wherein the ball of the ball-type valve has a diameter that is larger than a gap between the second end of the first curved wall and the side boundary of the ventilation end of the housing.

12. The valve assembly of claim 1, wherein the first curved wall and the second curved wall are disjoint.

13. A housing in a valve assembly for a fuel tank of a vehicle, the housing comprising:
an orifice coupled to a first vapor path, and
a head cage for confining movements of a ball of a ball-type valve that opens and closes a second vapor path, the head cage being defined by at least a plurality of walls comprising:
a first curved wall with a first end terminating at the orifice for the first vapor path and a second end terminating at a first terminating location proximate to a side boundary of the housing; and
a second curved wall with a third end terminating at the orifice for the first vapor path and a fourth end terminating at a second terminating location proximate to the side boundary of the housing.

14. The housing of claim 13, wherein a gap between the first end of the first curved wall and the third end of the second curved wall includes a portion of the orifice for the first vapor path of a Fill Limit Vent Valve (FLVV).

15. The housing of claim 14, wherein a diameter of the ball of the ball-type valve is larger than the gap.

16. The housing of claim 13, wherein the ball-type valve comprises a second orifice surrounded by a slanting surface that slants down towards the second orifice.

17. The housing of claim 16, wherein the slanting surface extends from the second orifice to the first curved wall and the second curved wall.

18. The housing of claim 17, wherein the slanting surface further extends to the side boundary of the housing.

19. The housing of claim 13, wherein movements of the ball of the ball-type valve is confined by the first curved wall, the second curved wall, and an interior surface of a canister when the canister is attached to the housing.

20. The housing of claim 13, wherein the first vapor path is associated with an FLVV for preventing overfilling of the fuel tank during a refueling event, and the second vapor path is associated with a Grade Vent Valve (GVV) for venting the fuel tank when the vehicle is parked on a grade.
